(19) United States
(12) Patent Application Publication
(10) Pub. No.: US 2015/0369464 A1
(43) Pub. Date: Dec. 24, 2015

(54) Multipurpose Multicolor LED Light Strip

(71) Applicant: Sun-Hsien Chang, Dong Guan City (CN)

(72) Inventor: Sun-Hsien Chang, Dong Guan City (CN)

(21) Appl. No.: 14/308,749

(22) Filed: Jun. 19, 2014

(51) Int. Cl. F21V 23/00; F21S 10/02; F21S 4/00

(52) U.S. Cl. CPC F21V 23/009; F21S 4/001; F21S 10/023; F21Y 2113/007

(57) ABSTRACT

A multipurpose multicolor LED light strip contains at least one bulb and two power cords, each bulb includes three wicks for illuminating three-color lights and a control chip for controlling the three wicks; the three wicks and the control chip are covered in a cavity of each bulb by a transparent medium; the two power cords are electrically connected with each bulb. The three wicks include a first wick for illuminating red light, a second wick for illuminating blue light, and a third wick for illuminating green light. The control chip is an IC chip, the at least one bulb is equidistantly arranged on the first power cord and the second power cord. Each of the first power cord and the second power cord is a phone charging power cable or a headphone power cable.

### FIELD OF THE INVENTION

The present invention relates to an LED light, and more particularly to a multipurpose multicolor LED light strip.

### BACKGROUND OF THE INVENTION

A conventional decorative light is comprised of two power cords and at least one bulb disposed between the two power cords. After conducting electricity, the at least one bulb illuminates colorful lights applicable for clothing, gifts, footwear, watches or various adornments. However, the at least one bulb exposes outdoors to damage easily. In addition, the conventional decorative light is in a large size, so it is not easy to be portable and stored. Furthermore, its usage is limited.

The present invention has arisen to mitigate and/or obviate the afore-described disadvantages.

### SUMMARY OF THE INVENTION

The primary objective of the present invention is to provide a multipurpose multicolor LED light strip which is simplified and durable.

To obtain the above objective, a multipurpose multicolor LED light strip provided by the present invention contains: at least one bulb and two power cords, each bulb including three wicks for illuminating three-color lights and a control chip for controlling the three wicks;

the three wicks and the control chip being covered in a cavity of each bulb by a transparent medium; the two power cords being electrically connected with each bulb.

Preferably, the three wicks include a first wick for illuminating red light, a second wick for illuminating blue light, and a third wick for illuminating green light.

Preferably, the control chip is an IC chip. Preferably, the at least one bulb is equidistantly arranged on the first power cord and the second power cord.

Preferably, each of the first power cord and the second power cord is a phone charging power cable or a headphone power cable.

Thereby, the three wicks and the control chip are covered in the cavity of each bulb by the transparent medium to avoid damage, and the first power cord and the second power cord conduct electricity to the three wicks, the control chip controls each bulb independently. Preferably, the three wicks illuminate the three-color lights, such as red light, blue light and green light, and a mixed light of the red light and the blue light, a mixed light of the red light and the green light, a mixed light of the blue light and the green light, and a mixed light of the red light, the blue light, and the green light, thus illumining lights in seven colors. Each of the first power cord and the second power cord is a phone charging power cable or a headphone power cable.

The control chip controls the three wicks to become bright or fade, thus generating different brightness. Thereby, the multipurpose multicolor LED light strip is applicable for clothing, gifts, footwear, watches or various adornments widely.

### BRIEF DESCRIPTION OF THE DRAWINGS

FIG. 1 is a plan view showing the assembly of a multipurpose multicolor LED light strip according to a preferred embodiment of the present invention.

### DETAILED DESCRIPTION OF THE PREFERRED EMBODIMENTS

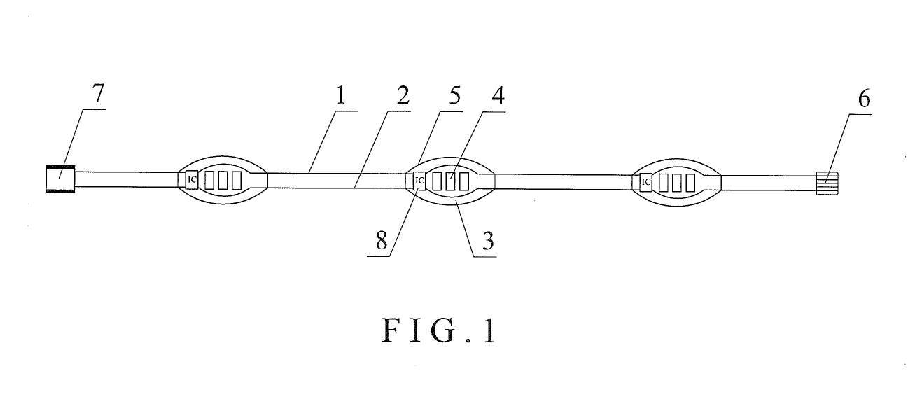

With reference to FIG. 1, a multipurpose multicolor LED light strip according to a preferred embodiment of the present invention comprises: a first power cord 1, a second power cord 2, and at least one bulb 3. Each bulb 3 includes three wicks 4 for illuminating three-color lights and a control chip 8 for controlling the three wicks 4; the three wicks 4 and the control chip 8 are covered in a cavity of each bulb 3 by a transparent medium 5, and the control chip 8 is an IC chip. The first power cord 1 and the second power cord 2 are electrically connected with each bulb 3 to form an electric circuit.

To connect the power supply, the first power cord 1 and the second power cord 2 easily, a slot interface 7 is fixed on a first end of the first power cord 1 and the second power cord 2, and an interface connector 6 is mounted on a second end of the first power cord 1 and the second power cord 2.

The three wicks 4 and the control chip 8 are covered in the cavity of each bulb 3 by the transparent medium 5 to avoid damage, and the first power cord 1 and the second power cord 2 conduct electricity to the three wicks 4, the control chip 8 controls each bulb independently. Preferably, the three wicks 4 illuminate the three-color lights, such as red light, blue light and green light, and a mixed light of the red light and the blue light, a mixed light of the red light and the green light, a mixed light of the blue light and the green light, and a mixed light of the red light, the blue light, and the green light, thus illumining lights in seven colors. Each of the first power cord and the second power cord is a phone charging power cable or a headphone power cable. The control chip 8 controls the three wicks 4 to become bright or fade, thus generating different brightness. Thereby, the multipurpose multicolor LED light strip is applicable for clothing, gifts, footwear, watches or various adornments widely.

While we have shown and described various embodiments in accordance with the present invention, it is clear to those skilled in the art that further embodiments may be made without departing from the scope of the present invention.

What is claimed is:

1. A multipurpose multicolor LED light strip comprising:
at least one bulb and two power cords, each bulb including three wicks for illuminating three-color lights and a control chip for controlling the three wicks;
the three wicks and the control chip being covered in a cavity of each bulb by a transparent medium; the two power cords being electrically connected with each bulb.

2. The multipurpose multicolor LED light strip as claimed in claim 1, wherein the three wicks include a first wick for illuminating red light, a second wick for illuminating blue light, and a third wick for illuminating green light.

3. The multipurpose multicolor LED light strip as claimed in claim 1, wherein the control chip is an IC chip.

4. The multipurpose multicolor LED light strip as claimed in claim 1, wherein the at least one bulb is equidistantly arranged on the first power cord and the second power cord.

5. The multipurpose multicolor LED light strip as claimed in claim 2, wherein the at least one bulb is equidistantly arranged on the first power cord and the second power cord.

6. The multipurpose multicolor LED light strip as claimed in claim 3, wherein the at least one bulb is equidistantly arranged on the first power cord and the second power cord.

7. The multipurpose multicolor LED light strip as claimed in claim 1, wherein each of the first power cord and the second power cord is a phone charging power cable or a headphone power cable.

8. The multipurpose multicolor LED light strip as claimed in claim 2, wherein each of the first power cord and the second power cord is a phone charging power cable or a headphone power cable.

9. The multipurpose multicolor LED light strip as claimed in claim 3, wherein each of the first power cord and the second power cord is a phone charging power cable or a headphone power cable.
